(19) United States
(12) Patent Application Publication
(10) Pub. No.: US 2012/0117004 A1
(43) Pub. Date: May 10, 2012

(54) REGIONAL WILD BIRD FOOD MIXTURES

(75) Inventor: John ROBINSON, Fairfield, CA (US)

(73) Assignee: SMG Brands, Inc., Wilmington, DE (US)

(21) Appl. No.: 13/250,433

(22) Filed: Sep. 30, 2011

Related U.S. Application Data
(60) Provisional application No. 61/388,492, filed on Sep. 30, 2010.

(51) Int. Cl. A23K 1/18; G06Q 90/00

(52) U.S. Cl. 705/500; 426/1

(57) ABSTRACT

Bird feed mixtures intrinsically attractive to desirable birds in a particular region (e.g., northeast, southeast, midwest, southwest, and west) and which attract more desirable birds than other bird feed mixtures. The bird feed mixtures comprise black oil sunflower seeds, sunflower chips, NYJER® seed (niger oilseed), and peanuts in combination with cherries and pumpkin seeds; cherries, pumpkin seeds, and safflower; blueberries and pumpkin seeds; blueberries, pumpkin seeds, and safflower; canola seed and cherries; canola seed, cherries, and safflower; almonds and millet, or almonds, red millet, and safflower.

### CROSS-REFERENCE TO RELATED PATENT APPLICATIONS

This patent application claims the benefit of U.S. Provisional Patent Application No. 61/388,492, filed Sep. 30, 2010, the disclosure of which is incorporated herein in its entirety.

### BACKGROUND OF THE INVENTION

(a) Field of the Invention

The invention relates to bird feed mixtures, and methods thereof, for attracting and feeding desirable birds in a particular region of the United States (e.g., northeast, southeast, midwest, southwest, and west).

(b) Description of the Related Art

Bird watching enthusiasts have long sought to attract desirable birds for observation and enjoyment. A variety of methods and systems have been employed to attract greater numbers of desirable birds including bird feed mixtures.

Bird feed mixtures usually comprise varying amounts of different food items typically consumed by birds such as seeds, nuts, fruits, and suet. Typical bird food mixtures comprise 95% grain products by weight (e.g., corn and milo), plus black oil sunflower, and white millet. Many variations of this typical food mixture exist, as exemplified by Wagner's® Four Season Wild Bird Food which comprises milo, white millet, cracked corn, and black oil sunflower seed and GRREAT CHOICE® Wild Bird Seed Mix which comprises milo, white millet, and black oil sunflower seeds.

Some bird feed mixtures are designed to be attractive to a given species of bird. For example, U.S. Patent Application Publication Nos. 2009/0304853 and 2009/0304900 disclose a mixture comprising thistle, red millet, and sunflower chips intrinsically attractive to desirable birds such as finches. See, also, Wagner's Cardinal Blend and Wagner's Finches Supreme. Other bird feed mixtures are marketed as formulated to attract a given category of birds such as songbirds. See, e.g., Wagner's Orange Raisin-Nut Premium Songbird Blend.

Other bird feed mixtures are labeled as blended for a given region. KAYTEE® Western, Southern, Northeast, and Midwest Regional Blends all appear to comprise sunflower hearts and chips, red millet, oil sunflower, safflower, and white millet. See KAYTEE® website. Additionally, Wagner's Regional Bird Food appear to comprise 25% black oil sunflower and striped sunflower seed plus safflower seeds. See Wagner's website.

While these various bird feed mixtures and systems may be attractive to desirable birds, there is still a need for a bird feed mixture that is intrinsically attractive to desirable birds in a particular region of the United States, as well as methods for attracting desirable birds in a particular region of the United States.

### BRIEF SUMMARY OF THE INVENTION

In one aspect, the invention provides a bird feed mixture that is intrinsically attractive to desirable birds. In another aspect, the invention provides a bird feed mixture that increases the number of desirable birds available for viewing by bird enthusiasts without regard to the type of bird feeder mechanism used to dispense the food. In another embodiment, the invention provides a mixture that is intrinsically attractive to desirable birds in a given region of the United States (e.g., northeast, southeast, midwest, southwest, and west) available for observation. In a further embodiment, the invention provides a method for formulating, marketing, and selling a bird feed mixture intrinsically attractive to desirable birds in a region of the United States (e.g., northeast, southeast, midwest, southwest, and west). These and other objects of the invention are met by one or more of the following embodiments.

A bird food mixture comprises black oil sunflower seeds, sunflower chips, NYJER® seed (niger oilseed), and peanuts, and further comprises: (a) cherries and pumpkin seeds; (b) cherries, pumpkin seeds, and safflower; (c) blueberries and pumpkin seeds; (d) blueberries, pumpkin seeds, and safflower; (e) canola seed and cherries; (f) canola seed, cherries, and safflower; (g) red millet and almonds; or (h) safflower, red millet, and almonds.

In one embodiment, the bird food mixture may comprise at least about 24.75%-29% black oil sunflower seeds by weight. In another embodiment, the bird food mixture may comprise at least about 24.75%, 25%, 25.25%, 27%, or 29% black oil sunflower seeds by weight. In one embodiment, the bird food mixture may comprise at least about 5%-15% sunflower chips by weight. In another embodiment, the bird food mixture may comprise at least about 5%, 7%, 8%, 10%, or 15% sunflower chips by weight. In one embodiment, the bird food mixture may comprise at least about 10%-18% NYJER® seed (niger oilseed) by weight. In another embodiment, the bird food mixture may comprise at least about 10%, 12%, 15.5%, 16%, 17.25%, or 18% NYJER® seed (niger oilseed) by weight.

In one embodiment, the bird food mixture may further comprise at least about 3%-20% peanuts by weight. In another embodiment, the bird food mixture may further comprise at least about 3%, 10%, 15%, or 20% peanuts by weight. In one embodiment, the bird food mixture may further comprise at least about 2%-5% raisins by weight. In another embodiment, the bird food mixture may further comprise at least about 2%, 3.75%, or 5% raisins by weight. In one embodiment, the bird food mixture may further comprise at least about 15%-25% white millet by weight. In another embodiment, the bird food mixture may further comprise at least about 15%, 15.5%, 16%, 17%, or 25% white millet by weight. In one embodiment, the bird food mixture may further comprise mineral oil. In another embodiment, the bird food mixture may further comprise at least about 0.06% mineral oil by weight.

In one embodiment, the bird food mixture may comprise cherries and pumpkin seeds. In another embodiment, the bird food mixture may comprise at least about 1% cherries and at least about 1% pumpkin seeds by weight. In one embodiment, the bird food mixture may comprise cherries, pumpkin seeds, and safflower. In another embodiment, the bird food mixture may comprise at least about 1% cherries, at least about 1% pumpkin seeds by weight, and at least about 5%, 12%, 14.25%, 15%, or 20% safflower by weight. In one embodiment, the bird food mixture may comprise blueberries and pumpkin seeds. In another embodiment, the bird food mixture may comprise at least about 0.5% blueberries and at least about 1% pumpkin seeds by weight. In one embodiment, the bird food mixture may comprise blueberries, pumpkin seeds, and safflower. In another embodiment, the bird food mixture may comprise at least about 0.5% blueberries and at least about 1% pumpkin seeds by weight, and at least about 5%, 12%, 14.25%, 15%, or 20% safflower by weight. In one embodiment, the bird food mixture may comprise canola seed and cherries. In another embodiment, the bird food mixture may comprise at least about 3.75% canola seed by weight and at least about 1% cherries. In one embodiment, the bird food mixture may comprise canola seed, cherries, and safflower. In another embodiment, the bird food mixture may comprise at least about 3.75% canola seed by weight, at least about 1% cherries, and at least about 5%, 12%, 14.25%, 15%, or 20% safflower by weight. In one embodiment, the bird food mixture may comprise almonds and red millet. In another embodiment, the bird food mixture may comprise at least about 1% or 5% almonds and at least about 5% or 7% red millet by weight. In one embodiment, the bird food mixture may comprise almonds, red millet, and safflower. In another embodiment, the bird food mixture may comprise at least about 1% or 5% almonds and at least about 5% or 7% red millet by weight, and at least about 5%, 12%, 14.25%, 15%, or 20% safflower by weight.

In one aspect, the invention provides a container, item, or package comprising the bird food mixture described herein.

In another aspect, the invention provides a method of manufacturing a bird food mixture comprising combining black oil sunflower seeds, NYJER® seed (niger oilseed), and peanuts, and further combining: (a) cherries and pumpkin seeds; (b) cherries, pumpkin seeds, and safflower; (c) blueberries and pumpkin seeds; (d) blueberries, pumpkin seeds, and safflower; (e) canola seed and cherries; (f) canola seed, cherries, and safflower; (g) red millet and almonds; or (h) safflower, red millet, and almonds. In one embodiment, the method of manufacturing described herein further comprises adding raisins and white millet to said mixture. In another embodiment, the method of manufacturing described herein further comprises adding comprises mineral oil to said mixture.

In another aspect, the invention provides a method for attracting desirable birds comprising placing the bird feed mixture described herein t a location where it is available to birds.

In a further aspect, the invention provides a method for increasing sales of a bird feed mixture comprising combining said bird feed mixture components to manufacture a bird feed mixture, wherein said components are selected based on the dietary needs of desirable birds in a given region, and identifying said mixture as suitable for birds of a specific region. In one embodiment, the method of increasing sales described herein further comprises labeling said bird feed mixture as formulated for a region. In another embodiment, the method of increasing sales described herein further comprises bagging said bird feed mixture. In another embodiment, the method of increasing sales described herein further comprises offering said bird feed mixture for sale.

In a still further aspect, the invention provides a method of attracting desirable birds comprising combining bird feed mixture components to manufacture a bird feed mixture as described herein, wherein said components are selected based on the dietary needs of desirable birds in a region, and making said mixture available to desirable birds.

In another embodiment, the invention provides a system of regional bird food mixtures comprising at least two mixtures of (a)-(e):
(a) a bird food mixture corresponding to a first region and comprising black oil sunflower seeds, sunflower chips, NYJER® seed (niger oilseed), peanuts, cherries, and pumpkin seeds;
(b) a bird food mixture corresponding to a second region and comprising black oil sunflower seeds, sunflower chips, NYJER® seed (niger oilseed), peanuts, blueberries, and pumpkin seeds;
(c) a bird food mixture corresponding to a third region and comprising black oil sunflower seeds, sunflower chips, NYJER® seed (niger oilseed), peanuts, canola seed, and cherries;
(d) a bird food mixture corresponding to a fourth region and comprising black oil sunflower seeds, sunflower chips, NYJER® seed (niger oilseed), peanuts, red millet, and almonds; and
(e) a bird food mixture corresponding to a fifth region and comprising black oil sunflower seeds, sunflower chips, NYJER® seed (niger oilseed), peanuts, safflower, red millet, and almonds.

In one embodiment, the system described herein further comprise raisins and white millet. In another embodiment, at least one of said bird food mixtures further comprise safflower. In another embodiment, at least one of said bird food mixtures further comprise mineral oil. In another embodiment, at least one of said regions are the northeast, southeast, midwest, southwest, or western regions of the United States.

The foregoing and other objects and aspects of the present invention are explained in greater detail in reference to the description set forth herein.

### DETAILED DESCRIPTION OF THE PREFERRED EMBODIMENTS

The invention relates to defined bird feed mixtures for attracting and feeding desirable birds. In particular, the invention relates to a bird feed mixture comprising various amounts of black oil sunflower seeds, sunflower chips, NYJER® seed (niger oilseed), and peanuts in addition to various amounts of almonds, blueberries, canola seed, cherries, pumpkin seeds, raisins, red millet, safflower, and white millet. Surprisingly, it has been found that the bird feed mixture of the invention is more attractive to desirable birds in each individual region of the United States than other bird feed mixtures.

### Definitions

Unless otherwise indicated, all terms used herein have the same meaning as they would to one skilled in the art.

### Regions

Regions of the United States may be defined by an assemblage of contiguous states but may also be defined by climate, geographical boundaries, breeding populations, and food availability. To create a region, general trends in bird distribution may be identified by studying the range maps included in Birds at Your Feeder by Erica H. Dunn and Diane L. Tessaglia-Hymes (W.W. Norton & Company, New York 1999) which summarizes the results of a North American (US and Canada) bird feeding study coordinated by Cornell Lab of Ornithology (“Project FeederWatch.”) Often, trends in bird distribution reflect natural limits to bird occurrence and physical or climate properties that affect bird distribution. For example, the Carolina Chickadee is a bird whose range is clearly limited to the southeastern United States, while the Cactus Wren is a bird whose range is particularly constrained to the southwestern United States. Weather also plays a role in bird distribution as some birds may not be as able as others to tolerate cold, wintry conditions and therefore have a range that is more restricted to southerly latitudes. See Audubon Society website. In addition, other physical attributes of the landscape (e.g., forests of the southeast and northeast, grasslands of the mid-west and Great Plains, the Rocky Mountains, and arid/desert-like habitat) all play a role in further influencing the distribution of birds. These factors may be taken into consideration when describing “regions” that logically separate different assemblages of birds in each particular region.

### Desirable Birds

Desirable birds may be song birds. In addition, other species (e.g., doves, pheasants, quail, woodpeckers) which may not be considered “song birds” are still considered desirable birds by those who like to feed and watch birds. Additionally, desirable birds may be organized by region by examining bird watching studies, including those conducted by the U.S. Geological Survey (USGS), to first determine desirable birds, and, then to match them to a particular region. See, e.g., Igl, Lawrence D. 1996. Bird Checklists of the United States. Jamestown, N.D.: Northern Prairie Wildlife Research Center Online. Exemplary lists of desirable bird species organized by region of the United States are shown in Table 1. This information may be taken into consideration when designating birds as desirable birds and creating different assemblages of desirable birds in each particular region.

TABLE 1
Desirable Bird Species by Exemplary Region of the United States

| Northeast | Midwest |
|---|---|
| Mourning Dove | Ring-necked Pheasant |
| Red-bellied Woodpecker | Mourning Dove |
| Downy Woodpecker | Red-bellied Woodpecker |
| Hairy Woodpecker | Downy Woodpecker |
| Blue Jay | Hairy Woodpecker |
| Black-capped Chickadee | Northern Flicker |
| Tufted Titmouse | Blue Jay |
| White-breasted Nuthatch | Black-capped Chickadee |
| American Tree Sparrow | Tufted Titmouse |
| Song Sparrow | White-breasted Nuthatch |
| Dark-eyed Junco | American Robin |
| Northern Cardinal | American Tree Sparrow |
| House Finch | Field Sparrow |
| American Goldfinch | Song Sparrow |
| Evening Grosbeak | Dark-eyed Junco |
| | Northern Cardinal |
| | Purple Finch |
| | House Finch |
| | Pine Siskin |
| | American Goldfinch |
| | Evening Grosbeak |

| Southeast | West |
|---|---|
| Mourning Dove | Ring-necked Pheasant |
| Red-bellied Woodpecker | California Quail |
| Downy Woodpecker | Band-tailed Pigeon |
| Blue Jay | Mourning Dove |
| Carolina Chickadee | Downy Woodpecker |
| Tufted Titmouse | Northern Flicker |
| Carolina Wren | Steller's Jay |
| Eastern Bluebird | Western Scrub-Jay |
| American Robin | Black-capped Chickadee |
| Northern Mockingbird | Mountain Chickadee |
| Brown Thrasher | Chestnut-backed Chickadee |
| Yellow-rumped Warbler | Oak Titmouse |
| Eastern Towhee | American Robin |
| Chipping Sparrow | Spotted Towhee |
| Field Sparrow | California Towhee |
| White-throated Sparrow | White-crowned Sparrow |
| Dark-eyed Junco | Golden-crowned Sparrow |
| Northern Cardinal | Dark-eyed Junco |
| Purple Finch | Cassin's Finch |
| House Finch | House Finch |
| American Goldfinch | Pine Siskin |
| | Lesser Goldfinch |
| | American Goldfinch |
| | Evening Grosbeak |

Southwest
Gambel's Quail
Mourning Dove
Inca Dove
Western Scrub-Jay
Cactus Wren
Northern Mockingbird
Curve-billed Thrasher
Yellow-rumped Warbler
Canyon Towhee
White-crowned Sparrow
Dark-eyed Junco
Pyrrhuloxia
House Finch
Pine Siskin
Lesser Goldfinch

### Bird Feed Mixtures

The bird feed mixture of the present invention may comprise various amounts of black oil sunflower seeds, sunflower chips, NYJER® seed (niger oilseed), and peanuts. In one embodiment, the bird feed mixture may comprise various amounts of black oil sunflower seeds, sunflower chips, NYJER® seed (niger oilseed), peanuts, raisins, and white millet. In another embodiment, the bird feed mixture comprises black oil sunflower seeds, sunflower chips, NYJER® seed (niger oilseed), and peanuts, further comprising various amounts of almonds, blueberries, canola seed, cherries, pumpkin seeds, raisins, red millet, safflower, and white millet. In another embodiment, the bird feed mixtures described herein comprise black oil sunflower seeds, sunflower chips, NYJER® seed (niger oilseed), and peanuts in combination with cherries and pumpkin seeds; cherries, pumpkin seeds, and safflower; blueberries and pumpkin seeds; blueberries, pumpkin seeds, and safflower; canola seed and cherries; canola seed, cherries, and safflower; almonds and red millet, or almonds, red millet and safflower. In another embodiment, the bird feed mixtures described herein comprise black oil sunflower seeds, sunflower chips, NYJER® seed (niger oilseed), peanuts, raisins, and white millet in combination with cherries and pumpkin seeds; cherries, pumpkin seeds, and safflower; blueberries and pumpkin seeds; blueberries, pumpkin seeds, and safflower; canola seed and cherries; canola seed, cherries, and safflower; almonds and red millet, or almonds, red millet and safflower. In a further embodiment, the bird feed mixture may comprise various amounts of apples (dried), artificial color, BHT (a preservative), biotin, calcium (e.g., in the form of calcium carbonate, calcium iodate, or calcium pantothenate), canary grass seed, cherry flavor, cholecalciferol (source of vitamin D3), choline chloride, cobalt carbonate, copper oxide, copper sulfate, corn (including but not limited to cracked corn and cornmeal), cranberries, dextrose, DL-methionine, ferrous carbonate, ferrous sulfate, finch millet, flax seed, folic acid, gelatin, ground wheat, honey, L-lysine, manganous oxide, menadione sodium bisulfite complex (source of vitamin K activity), milo, mineral oil, mixed tocopherols (a natural preservative), niacin, oatmeal, pantothenate, pecans, pine nuts, pistachios, pyridoxine hydrochloride, raisins, raspberries, riboflavin, salt, sodium bisulfite complex (source of vitamin K activity), sodium selenite, soy oil, squash seeds, striped sunflower, suet, thiamine, mononitrate, vitamin A, vitamin B12, vitamin D, vitamin E, walnuts, white millet, or zinc oxide. In yet another embodiment, the bird feed mixture may comprise any combination of at least two of the components described herein. In a preferred embodiment, the bird feed mixture may comprise any combination of at least three, four, or five of the components described herein. In another preferred embodiment, the bird feed mixture may comprise any combination of at least six, seven, eight, nine, ten, eleven, twelve, thirteen, fourteen, or fifteen of the components described herein. In another embodiment, the bird food mixture may consist of any of the foregoing components. In yet another embodiment, the bird food mixture may consist essentially of any of the foregoing components.

The bird food mixture may comprise at least one of the components described herein in an amount at least about 0.01, 0.02, 0.03, 0.04, 0.05, 0.06, 0.07, 0.08, 0.09, or 0.10% by weight. In another embodiment, the bird food mixture may comprise at least one of the components described herein in an amount at least about 0.1, 0.2, 0.3, 0.4, 0.5, 0.6, 0.7, 0.8, 0.9, 1, 2, 3, 4, 5, 6, 7, 8, 9, or 10% by weight. In further embodiment, the bird food mixture may comprise at least one of the components described herein in an amount at least about 10, 11, 12, 13, 14, 15, 16, 17, 18, 19, or 20% by weight. In yet another embodiment, the bird food mixture may comprise at least one of the components described herein in an amount at least about 10, 20, 21, 22, 23, 24, 25, 26, 26, 27, 28, 29, 30, 31, 32, 33, 34, 35, 36, 37, 38, 39, 40, 45, or 50% by weight.

The bird food mixture may comprise at least one of the components described herein in an amount at least about 1.0, 1.25, 1.50, 1.75, 2.0, 2.25, 2.50, 2.75, 3.0, 3.25, 3.50, 3.75, 4.0, 4.25, 4.50, 4.75, 5.0, 5.25, 5.50, 5.75, 6.0, 6.25, 6.50, 6.75, 7.0, 7.25, 7.50, 7.75, 8.0, 8.25, 8.50, 8.75, 9.0, 9.25, 9.50, 9.75, or 10% by weight. In another embodiment, the bird food mixture may comprise at least one of the components described herein in an amount at least about 10, 10.25, 10.50, 10.75, 11, 11.25, 11.50, 11.75, 12, 12.25, 12.50, 12.75, 13, 13.25, 13.50, 13.75, 14, 14.25, 14.50, 14.75, 15, 15.25, 15.50, 15.75, 16, 16.25, 16.50, 16.75, 17, 17.25, 17.50, 17.75, 18, 18.25, 18.50, 18.75, 19, 19.25, 19.50, 19.75, or 20% by weight. In further embodiment, the bird food mixture may comprise at least one of the components described herein in an amount at least about 20, 20.25, 20.50, 20.75, 21, 21.25, 21.50, 21.75, 22, 22.25, 22.50, 22.75, 23, 23.25, 23.50, 23.75, 24, 24.25, 24.50, 24.75, 25, 25.25, 25.50, 25.75, 26, 26.25, 26.50, 26.75, 27, 27.25, 27.50, 27.75, 28, 28.25, 28.50, 28.75, 29, 29.25, 29.50, 29.75, or 30% by weight.

The bird food mixture may comprise at least one of the components described herein in an amount at least about 0.01%-0.05%, 0.05%-0.10%, 0.10%-0.50%, 0.50%-1.0%, 1%-5%, or 5%-10% by weight. In another embodiment, the bird food mixture may comprise at least one of the components described herein in an amount at least about 10%-30%, 15%-30%, 20%-30%, or 25%-30% by weight.

The bird feed mixture may comprise black oil sunflower seeds in an amount at least about 10%-40%, 20%-40%, 20%-30%, 22%-30%, 23%-30%, 24%-30%, 24%-29%, 25%-29%, or 27%-29% by weight. In an another embodiment, the amount of black oil sunflower seeds is at least about 24.75%-29% by weight. In an exemplary embodiment, the amount of black oil sunflower seeds is at least about 24.75%, 25%, 25.25%, 27%, or 29% by weight.

The bird feed mixture may comprise sunflower chips in an amount at least about 1%-20%, 2%-15%, 3%-15%, 4%-15%, 5%-15%, 5%-15%, 6%-15%, 7%-15%, 8%-15%, or 10%-15% by weight. In another embodiment, the bird feed mixture comprises sunflower chips in an amount at least about 5%-15% by weight. In an exemplary embodiment, the amount of sunflower chips is at least about 5%, 7%, 8%, 10%, or 15% by weight.

The bird feed mixture may comprise NYJER® seed (niger oilseed) in an amount at least about 5%-20%, 6%-20%, 7%-20%, 8%-20%, 9%-20%, or 10%-20% by weight. In another embodiment, the amount of NYJER® seed (niger oilseed) is at least about 10%-18% by weight. In an exemplary embodiment, the amount of NYJER® seed (niger oilseed) is at least about 10%, 12%, 15.5%, 16%, 17.25%, or 18% by weight.

The bird feed mixture may comprise peanuts in an amount at least about 1%-20%, 3%-20%, 3%-15%, or 3%-10% by weight. In another embodiment, the bird feed mixture comprises peanuts in an amount at least about 3%-20% by weight. In an exemplary embodiment, the amount of peanuts is at least about 3%, 10%, 15%, or 20% by weight.

The bird feed mixture may comprise almonds in an amount at least about 1%, 2%, 3%, 4%, 5%, 6%, 7%, 8%, 9%, or 10% by weight. In another embodiment, the bird feed mixture comprises almonds in an amount at least about 1%-5% by weight. In an exemplary embodiment, the amount of almonds is at least about 1% or 5% by weight.

The bird feed mixture may comprise blueberries in an amount at least about 0.1%, 0.2%, 0.3%, 0.4%, 0.5%, 0.6%, 0.7%, 0.8%, 0.9%, or 1% by weight. In another embodiment, the bird feed mixture comprises blueberries in an amount at least about 0.425%-0.550% by weight. In an exemplary embodiment, the amount of blueberries is at least about 0.5% by weight.

The bird feed mixture may comprise canola seed in an amount at least about 1%, 2%, 3%, 4%, 5%, 6%, 7%, 8%, 9%, or 10% by weight. In another embodiment, the bird feed mixture comprises canola seed in an amount at least about 3%-5% by weight. In an exemplary embodiment, the amount of canola seed is at least about 3.75% by weight.

The bird feed mixture may comprise cherries in an amount at least about 1%, 2%, 3%, 4%, 5%, 6%, 7%, 8%, 9%, or 10% by weight. In another embodiment, the bird feed mixture comprises cherries in an amount at least about 0.75%-1.50% by weight. In an exemplary embodiment, the amount of cherries is at least about 1% by weight.

The bird feed mixture may comprise pumpkin seeds in an amount at least about 1%, 2%, 3%, 4%, 5%, 6%, 7%, 8%, 9%, or 10% by weight. In another embodiment, the bird feed mixture comprises pumpkin seeds in an amount at least about 0.75%-1.50% by weight. In an exemplary embodiment, the amount of pumpkin seeds is at least about 1% by weight.

The bird feed mixture may comprise red millet in an amount at least about 1%-20%, 1%-10%, or 4%-9% by weight. In another embodiment, the bird feed mixture comprises red millet in an amount at least about 5%-7% by weight. In an exemplary embodiment, the amount of red millet is at least about 5% or 7% by weight.

The bird feed mixture may comprise raisins in an amount at least about 0.1%-10% or 1%-5% by weight. In another embodiment, the bird feed mixture comprises raisins in an amount at least about 2%-5% by weight. In an exemplary embodiment, the amount of raisins is at least about 2%, 3.75%, or 5% by weight.

The bird feed mixture may comprise safflower in an amount at least about 1%-20%, 1%-15%, or 10%-15%. In another embodiment, the bird feed mixture comprises safflower in an amount at least about 12%-15% by weight. In an exemplary embodiment, the amount of safflower is at least about 12.5%, 14.75%, or 15% by weight.

The bird feed mixture may comprise white millet in an amount at least about 5%-30% or 15%-30% by weight. In another embodiment, the bird feed mixture comprises white millet in an amount at least about 15%-25% by weight. In an exemplary embodiment, the amount of white millet is at least about 15%, 15.5%, 16%, 17%, or 25% by weight.

The bird feed mixture may comprise mineral oil in an amount at least about 0.01%, 0.02%, 0.03%, 0.04%, 0.05%, 0.06%, 0.07%, 0.08%, 0.09% or 1% by weight. In another embodiment, the bird feed mixture comprises mineral oil in an amount at least about 0.04%-0.07% by weight. In an exemplary embodiment, the amount of white millet is at least about 0.06% by weight.

The bird feed mixture may comprise black oil sunflower seeds in an amount at least about 24.75%-29% by weight, sunflower chips in an amount at least about 5%-15% by weight, NYJER® seed (niger oilseed) in an amount at least about 10%-18% by weight, and peanuts in an amount at least about 3%-20% by weight. The bird feed mixture may further comprise almonds in an amount at least about 1%-5% by weight, blueberries in an amount at least about 0.1%-1% by weight, canola seeds in an amount at least about 1%-5% by weight, cherries in an amount at least about 0.1%-5% by weight, pumpkin seeds in an amount at least about 0.75%-1.5% by weight, safflower in an amount at least about 5%-15% by weight, raisins in an amount at least about 3.75%-5% by weight, red millet in an amount of at least about 5%-7% by weight, white millet in an amount at least about 15%-25% by weight. The bird feed mixture may still further comprise mineral oil in an amount at least about 0.01%-0.1% by weight.

The bird feed mixture may comprise black oil sunflower seeds in an amount at least about 24.75%, 25%, 25.25%, 27%, or 29% by weight, sunflower chips in an amount at least about 5%, 7%, 8%, 10%, or 15% by weight, NYJER® seed (niger oilseed) in an amount at least about 10%, 12%, 15.5%, 16%, 17.25%, or 18% by weight, and peanuts in an amount at least about 3%, 10%, 15%, or 20% by weight. The bird feed mixture may further comprise almonds in an amount at least about 1% or 5% by weight, blueberries in an amount at least about 0.5% by weight, canola seeds in an amount at least about 3.75% by weight, cherries in an amount at least about 1% by weight, pumpkin seeds in an amount at least about 1% by weight, safflower in an amount at least about 5%, 12%, 14.75%, or 15% by weight, raisins in an amount at least about 2%, 3.75%, or 5% by weight, red millet in an amount of at least about 5% or 7% by weight, or white millet in an amount at least about 15%, 15.5%, 16%, 17%, 25% by weight. The bird feed mixture may still further comprise mineral oil in an amount of at least about 0.06% by weight.

The bird feed mixture may comprise artificial color, BHT (a preservative), biotin, calcium (e.g., in the form of calcium carbonate, calcium iodate, or calcium pantothenate), canary grass seed, cherry flavor, cholecalciferol (source of vitamin D3), choline chloride, cobalt carbonate, copper oxide, copper sulfate, corn (including but not limited to cracked corn), raspberries, dextrose, DL-methionine, cranberries, ferrous carbonate, ferrous sulfate, finch millet, flax seed, folic acid, gelatin, ground wheat, honey, L-lysine, manganous oxide, menadione sodium bisulfate complex (source of vitamin K activity), milo, mineral oil, mixed tocopherols (a natural preservative), niacin, pantothenate, pecans, pinenuts, pistachios, pyridoxine hydrochloride, riboflavin, salt, sodium bisulfate complex (source of vitamin K activity), sodium selenite, soy oil, striped sunflower, thiamine, mononitrate, vitamin A, vitamin B12, vitamin D, vitamin E, walnuts, or zinc oxide in an amount at least about 0.01, 0.02, 0.03, 0.04, 0.05, 0.06, 0.07, 0.08, 0.09, 0.1, 0.2, 0.3, 0.4, 0.5, 0.6, 0.7, 0.8, 0.9, 1, 2, 3, 4, 5, 6, 7, 8, 9, 10% by weight or 0.01%-10% by weight.

The bird feed mixture may comprise black oil sunflower seeds in an amount at least about 24.75%-29% by weight, sunflower chips in an amount at least about 5%-15% by weight, NYJER® seed (niger oilseed) in an amount at least about 10%-18% by weight, peanuts in an amount at least about 3%-20% by weight, and further comprise:
(a) cherries in an amount at least about 0.1%-5% by weight and pumpkin seeds in an amount at least about 0.1-10% by weight;
(b) cherries in an amount at least about 0.1%-5% by weight, pumpkin seeds in an amount at least about 0.1-5% by weight, and safflower in an amount at least about 5%-15% by weight;
(c) blueberries in an amount at least about 0.1%-1% by weight and pumpkin seeds in an amount at least about 0.1-5% by weight;
(d) blueberries in an amount at least about 0.1%-1% by weight, pumpkin seeds in an amount at least about 0.1-5% by weight, and safflower in an amount at least about 5%-15% by weight;
(e) canola seeds in an amount at least about 1%-5% by weight and cherries in an amount at least about 0.1%-5% by weight;
(f) canola seeds in an amount at least about 1%-5% by weight, cherries in an amount at least about 0.1%-5% by weight, and safflower in an amount at least about 5%-15% by weight;
(g) almonds in an amount at least about 1%-5% by weight and red millet in an amount of at least about 5%-7% by weight; or
(h) almonds in an amount at least about 1%-5% by weight, red millet in an amount of at least about 5%-7% by weight, and safflower in an amount at least about 5%-15% by weight.
   The bird feed mixture may further comprise raisins in an amount at least about 1%-5% by weight, and white millet in an amount at least about 15%-25% by weight. The bird feed mixture may still further comprise at least about 0.01%-0.1% by weight mineral oil.

The bird feed mixture may comprise black oil sunflower seeds in an amount at least about 24.75%, 25%, 25.25%, 27%, or 29% by weight, sunflower chips in an amount at least about 5%, 7%, 8%, 10%, or 15% by weight, NYJER® seed (niger oilseed) in an amount at least about 10%, 12%, 15.5%, 16%, 17.25%, or 18% by weight, and peanuts in an amount at least about 3%, 10%, 15%, or 20% by weight and further comprise almonds in an amount at least about 1% or 5% by weight, blueberries in an amount at least about 0.5% by weight, canola seeds in an amount at least about 3.75% by weight, cherries in an amount at least about 1% by weight, pumpkin seeds in an amount at least about 1% by weight, safflower in an amount at least about 5%, 12%, 14.75%, or 15% by weight, raisins in an amount at least about 2%, 3.75%, or 5% by weight, red millet in an amount of at least about 5% or 7% by weight, or white millet in an amount of at least about 15%, 15.5%, 16%, 17%, or 25% by weight. The bird feed mixture may still further comprise mineral oil in an amount of at least about 0.06% by weight.

The bird feed mixture may comprise black oil sunflower seeds in an amount at least about 24.75%, 25%, 25.25%, 27%, or 29% by weight, sunflower chips in an amount at least about 5%, 7%, 8%, 10%, or 15% by weight, NYJER® seed (niger oilseed) in an amount at least about 10%, 12%, 15.5%, 16%, 17.25%, or 18% by weight, and peanuts in an amount at least about 3%, 10%, 15%, or 20% by weight, and further comprise:
(a) cherries in an amount at least about 1% by weight and pumpkin seeds in an amount at least about 1% by weight;
(b) cherries in an amount at least about 1% by weight, pumpkin seeds in an amount at least about 1% by weight, and safflower in an amount at least about 5%, 12%, 14.75%, or 15% by weight;
(c) blueberries in an amount at least about 0.5% by weight and pumpkin seeds in an amount at least about 1% by weight;
(d) blueberries in an amount at least about 0.5% by weight, pumpkin seeds in an amount at least about 1% by weight, and safflower in an amount at least about 5%, 12%, 14.75%, or 15% by weight;
(e) canola seeds in an amount at least about 3.75% by weight and cherries in an amount at least about 1% by weight
(f) canola seeds in an amount at least about 3.75% by weight, cherries in an amount at least about 1% by weight, and safflower in an amount at least about 5%, 12%, 14.75%, or 15% by weight
(g) almonds in an amount at least about 1% or 5% by weight and red millet in an amount of at least about 5% or 7% by weight; or
(h) almonds in an amount at least about 1% or 5% by weight, safflower in an amount at least about 5%, 12%, 14.75%, or 15% by weight, and, red millet in an amount of at least about 5% or 7% by weight.
   The bird feed mixture may further comprise raisins in an amount at least about 2%, 3.75%, or 5% by weight and white millet in an amount at least about 15%, 15.5%, 16%, 17%, or 25% by weight. The bird feed mixture may still further comprise mineral oil in an amount of at least about 0.06% by weight.

The bird feed mixture may comprise at least about 63% black oil sunflower seeds, NYJER® seed (niger oilseed), peanuts, cherries, and pumpkin seeds by weight. In one embodiment, the bird feed mixture may comprise at least about 62% black oil sunflower seeds, NYJER® seed (niger oilseed), peanuts, blueberries, and pumpkin seeds by weight. In another embodiment, the bird feed mixture may comprise at least about 59% black oil sunflower seeds, NYJER® seed (niger oilseed), peanuts, canola seed, and cherries by weight. In another embodiment, the bird feed mixture may comprise at least about 70% black oil sunflower seeds, NYJER® seed (niger oilseed), peanuts, red millet, and almonds by weight. In another embodiment, the bird feed mixture may comprise at least about 63% black oil sunflower seeds, NYJER® seed (niger oilseed), peanuts, safflower, red millet, and almonds by weight. In a further embodiment, the bird feed mixture may comprise at least about 55% black oil sunflower seeds, NYJER® seed (niger oilseed), peanuts, safflower, red millet, and almonds by weight. In one embodiment, the balance of the weight of any given bird food mixture may be brought to 100% by adding black oil sunflower seeds, sunflower chips, or white millet.

The bird feed mixture of the invention may be placed in a container, item, bag, or package. For example, the bird feed mixture may be packaged for commercial availability. Further, the container of bird feed mixture may be identified as adapted for a particular region, attractive to an assemblage of desirable birds, or adapted to be attractive to an assemblage of desirable birds in a particular region. For example, the container of bird feed mixture may be labelled, including labelled as adapted for a particular region, attractive to an assemblage of desirable birds, or adapted to be attractive to an assemblage of desirable birds in a particular region. The bird feed mixtures described herein may be marketed including advertised as adapted for a particular region, attractive to an assemblage of desirable birds, or adapted to be attractive to an assemblage of desirable birds in a particular region.

### Methods

The bird feed mixture of the invention may be produced by a method comprising combining the components described herein in the amounts set forth herein. The invention also provides for a method of feeding birds comprising supplying the bird feed mixture of the invention. The invention also provides for methods of attracting desirable birds, including but not limited to songbirds, comprising placing the bird feed mixture as described herein at a location where said desirable birds can find and consume said bird feed mixture.

The invention provides a method for marketing a bird feed mixture comprising combining components to manufacture a bird feed mixture, wherein said bird feed mixture comprises components that were selected based on the dietary needs of desirable birds in a given region.

The invention provides for a method of attracting desirable birds comprising making a bird feed mixture available to desirable birds, wherein said bird feed mixture comprises components that were selected based on the dietary needs of desirable birds in a given region. The invention also provides for a method of attracting desirable birds in a geographic region comprising making a bird feed mixture available to desirable birds, wherein said bird feed mixture comprises components that were selected based on the dietary needs of desirable birds in said region.

The invention also provides for method for increasing sales of a bird feed mixture comprising combining components to make a bird seed mixture, wherein said bird feed mixture comprises components that were selected based on the dietary needs of desirable birds in a given region.

Another embodiment of the invention is a method for formulating a bird feed mixture to attract desirable birds in a region comprising combining components to make a bird seed mixture, wherein said bird feed mixture comprises components that were selected based on the dietary needs of desirable birds in a given region.

The methods described herein may further comprise offering said bird feed mixture in said region. The methods described herein may also comprise labeling a bird feed mixture as adapted to said region. The invention may also comprise bagging a bird feed mixture or offering a bird feed mixture for sale, wherein said bird feed mixture comprises components that were selected based on the dietary needs of desirable birds in a given region. In another embodiment, the components are selected to attract desirable birds of a particular region. In a further embodiment, the regions may be the northeast, southeast, midwest, west, or southwest regions of the United States.

### Systems

The invention also provides a system of regional bird food mixtures comprising at least one, two, three, four, five, six, seven, eight, nine, or ten bird food mixtures. The individual bird food mixtures described herein may correspond to a given region, wherein said region may be defined by geography, breeding populations of birds, political boundaries (e.g., an assemblage of states), prevailing climate conditions (e.g., microclimates, USDA plant hardiness zones), physical barriers to distribution (e.g., a region circumscribed by mountains, deserts, rivers, lakes), development (e.g., suburbs), or availability of food items. In one embodiment, the system may comprise (a) a first bird food mixture corresponding to a first region, (b) a second bird food mixture corresponding to a second region, (c) a third bird food mixture corresponding to a third region, (d) a fourth bird food mixture corresponding to a fourth region, and (e) a fifth bird food mixture corresponding to a fifth region. In another embodiment, the system may comprise (a) a first bird food mixture corresponding to a first geographic region, (b) a second bird food mixture corresponding to a second geographic region, (c) a third bird food mixture corresponding to a third geographic region, (d) a fourth bird food mixture corresponding to a fourth geographic region, and (e) a fifth bird food mixture corresponding to a fifth geographic region. In another embodiment, the system may comprise (a) a first bird food mixture corresponding to a first climate region, (b) a second bird food mixture corresponding to a second climate region, (c) a third bird food mixture corresponding to a third climate region, (d) a fourth bird food mixture corresponding to a fourth climate region, and (e) a fifth bird food mixture corresponding to a fifth climate region. In further embodiment, the system may comprise (a) a first bird food mixture corresponding to a first region defined by breeding/wintering populations of desirable birds, (b) a second bird food mixture corresponding to a second region defined by breeding/wintering populations of desirable birds, (c) a third bird food mixture corresponding to a third region defined by breeding/wintering populations of desirable birds, (d) a fourth bird food mixture corresponding to a fourth region defined by breeding/wintering populations of desirable birds, and (e) a fifth bird food mixture corresponding to a fifth region defined by breeding/wintering populations of desirable birds.

In one embodiment, the system may comprise (a) a first bird food mixture corresponding to a first geographic region and comprising black oil sunflower seeds, sunflower chips, NYJER® seed (niger oilseed), peanuts, cherries, and pumpkin seeds; (b) a second bird food mixture corresponding to a second geographic region and comprising black oil sunflower seeds, sunflower chips, NYJER® seed (niger oilseed), peanuts, blueberries, and pumpkin seeds; (c) a third bird food mixture corresponding to a third geographic region and comprising black oil sunflower seeds, sunflower chips, NYJER® seed (niger oilseed), peanuts, canola seed, and cherries; (d) a fourth bird food mixture corresponding to a fourth geographic region and comprising black oil sunflower seeds, sunflower chips, NYJER® seed (niger oilseed), peanuts, red millet, and almonds; and (e) a fifth bird food mixture corresponding to a fifth geographic region and comprising black oil sunflower seeds, sunflower chips, NYJER® seed (niger oilseed), peanuts, safflower, red millet, and almonds.

In another embodiment, the system may comprise (a) a first bird food mixture corresponding to a first geographic region and comprising black oil sunflower seeds, sunflower chips, NYJER® seed (niger oilseed), peanuts, raisins, white millet, cherries, and pumpkin seeds; (b) a second bird food mixture corresponding to a second geographic region and comprising black oil sunflower seeds, sunflower chips, NYJER® seed (niger oilseed), peanuts, raisins, white millet, blueberries, and pumpkin seeds; (c) a third bird food mixture corresponding to a third geographic region and comprising black oil sunflower seeds, sunflower chips, NYJER® seed (niger oilseed), peanuts, raisins, white millet, canola seed, and cherries; (d) a fourth bird food mixture corresponding to a fourth geographic region and comprising black oil sunflower seeds, sunflower chips, NYJER® seed (niger oilseed), peanuts, raisins, white millet, red millet, and almonds; and (e) a fifth bird food mixture corresponding to a fifth geographic region and comprising black oil sunflower seeds, sunflower chips, NYJER® seed (niger oilseed), peanuts, raisins, white millet, safflower, red millet, and almonds.

Further embodiments of the present invention will now be described with reference to the following examples. The examples contained herein are offered by way of illustration and not by any way of limitation.

### EXAMPLES

### Example 1

### Selection of the Bird Feed Mixture

The components and amounts of each of the bird food mixtures described herein were developed by first determining the five most desirable bird species in each of five regions (e.g., northeast, southeast, midwest, western, and southwest.) Each of the bird food mixtures was then designed to match the dietary needs of those five species. See Birds at Your Feeder (see citation above), and The Birds of North America series published by the Academy of Natural Sciences (Philadelphia, Pa.) and the American Ornithologists' Union (Washington, D.C.) for dietary needs. This process yielded at least six exemplary regional bird feed mixtures are described in Table 2:

TABLE 2
Regional Blends

| | |
|---|---|
| Ingredient | % |

Northeast

| | |
|---|---|
| Black Oil Sunflower Seeds | 25.25 |
| NYJER ® seed (niger oilseed) | 16 |
| Peanuts | 15 |
| Sunflower Chips | 7 |
| White Millet | 16 |
| Raisins | 3.75 |
| Mineral Oil | 0.06 |
| Cherries | 1 |
| Pumpkin Seeds | 1 |
| Safflower | 15 |
| Total (approx.) | 100 |

Midwest

| | |
|---|---|
| Black Oil Sunflower Seeds | 25 |
| NYJER ® seed (niger oilseed) | 17.25 |
| Peanuts | 10 |
| Sunflower Chips | 7 |
| White Millet | 16 |
| Raisins | 5 |
| Mineral Oil | 0.06 |
| Cherries | 1 |
| Canola Seed | 3.75 |
| Safflower | 15 |
| Total (approx.) | 100 |

Southeast

| | |
|---|---|
| Black Oil Sunflower Seeds | 24.75 |
| NYJER ® seed (niger oilseed) | 12 |
| Peanuts | 20 |
| Sunflower Chips | 5 |
| White Millet | 17 |
| Raisins | 5 |
| Mineral Oil | 0.06 |
| Blueberries | 0.5 |
| Pumpkin Seeds | 1 |
| Safflower | 14.75 |
| Total (approx.) | 100 |

West

| | |
|---|---|
| Black Oil Sunflower Seeds | 29 |
| NYJER ® seed (niger oilseed) | 18 |
| Peanuts | 15 |
| Sunflower Chips | 8 |
| White Millet | 15 |
| Raisins | 5 |
| Mineral Oil | 0.06 |
| Almonds | 5 |
| Red Millet | 5 |
| Total (approx.) | 100 |

Southwest (1)

| | |
|---|---|
| Black Oil Sunflower Seeds | 27 |
| NYJER ® seed (niger oilseed) | 15.5 |
| Peanuts | 10 |
| Sunflower Chips | 10 |
| White Millet | 15.5 |
| Raisins | 5 |
| Mineral Oil | 0.06 |
| Almonds | 5 |
| Red Millet | 7 |
| Safflower | 5 |
| Total (approx.) | 100 |

Southwest (2)

| | |
|---|---|
| Black Oil Sunflower Seeds | 27 |
| NYJER ® seed (niger oilseed) | 10 |
| Peanuts | 3 |
| Sunflower Chips | 15 |
| White Millet | 25 |
| Raisins | 2 |
| Mineral Oil | 0.06 |
| Almonds | 1 |
| Red Millet | 5 |
| Safflower | 12 |
| Total (approx.) | 100 |

### Example 2

### Study Protocol for Comparing Regional Bird Feed Mixtures to Three Other Bird Feed Mixtures

Four combinations of bird feed mixtures were tested for their ability to attract desirable birds: (1) a regional bird feed mixture (e.g., Northeast, Southeast, Midwest, West, and Southwest described in Example 1 and Table 2); (2) Wagner's Regional Blend comprising white millet, black oil sunflower seeds, cracked corn, milo, striped sunflower, and safflower; (3) KAYTEE® Basic Wild Bird Food comprising grain products, black oil sunflowers, calcium carbonate, vitamin A, and vitamin D; and (4) ordinary wild bird food comprising 95% grain products by weight (corn and milo), black oil sunflowers, and white millet.

Two sets of studies were conducted, the first lasting 6 weeks and using the Northeast, Midwest, Western, Southeast, and Southwest (1) bird feed mixtures and the second lasting 3.5 weeks using Southwest (2) bird feed mixture. These were “blind studies” where the observers did not know the name brand or composition of the bird feed mixtures being tested.

### Station Set-up and Feeder Type

### Station Set-up

A station was constructed for attracting, feeding, and observing birds outdoors using two different bird feed mixtures at a time to compare their ability to attract different birds. Each Station was divided into a “Home A” and a “Home B”, separated by 20 feet. Two feeders (Woodlink Hopper Feeder—GGPRO5) were located at Home A and were filled with one bird feed mixture and an identical two feeders were located at Home B and were filled with a different bird feed mixture. The feeders were placed in a line that the observer could face during data collection periods. An effort was made to place the feeders equal distances from cover (i.e., trees, shrubs, and other obstructions.) Feeders were placed at an angle so that one could observe birds feeding on both sides of the feeder.

### Filling and Weighing Feeders:

First, the feeders were filled with black oil sunflower for a period of at least five days before initiation of Surveys to attract birds to the Station. On each day that Surveys are conducted, the feeders were filled at least 30 minutes prior to the observation period with enough food to completely fill the feeder. Any bird food mixture that was leftover from the previous day was discarded before filling feeders with fresh bird food mixture. At each Station feeders were filled according to a rotation pattern where each of the four bird food mixtures were tested against each other [e.g., bird food mixture (1) was compared to bird food mixture (2), bird food mixture (1) was compared to bird food mixture (3), bird food mixture (1) was compared to bird food mixture (4)]. The type of food placed in each feeder changed six times during the course of the experiment. A 2-day interim period was scheduled between each rotation. During this 2-day interim period, feeders were filled once each day using the bird food mixtures, but no information was collected.

### Observations

### Bird Count Method: (Frequency, Timing, Details)

Surveys were conducted between the times of 30 minutes after sunrise and 30 minutes before sunset with an effort to schedule survey times that coincide with periods of frequent bird feeding. Participants also worked to conduct the surveys at the same time during the day for every day of the Survey with a one hour grace period. Specific weather conditions during each field watch were noted by the study participants. On occasion, surveys were carried out during periods of light precipitation, however, they were postponed during times of heavy precipitation during which birds do not frequent feeders.

The Surveys were conducted according to the following protocol:
(1) The timeline of the study was divided into six “Blocks.”
(2) Each “Block” consisted of a 2-day or 4-day period.
(3) During each “Block,” the Station consisting of 4 feeders were surveyed once per day, for the duration of the block.
(4) Blocks were separated by a period of two days during which time no Surveys were taken. During this 2-day interim period, feeders were filled once each day with the food blends specified for the next scheduled Block according to a food rotation schedule.
(5) At each Station, birds visiting the feeders were observed for a period of 60 minutes during each Block. All bird species that visited the feeders were counted, with the following exceptions:
   (a) Birds that visit a feeder, drop to the ground or fly to a nearby tree/shrub, and then return to the feeder were only counted once.
   (b) Birds were only counted when they are on the feeder or perched on top of the feeder. Birds perched on shepherd's hangers or on the ground were not counted.
(6) After arriving at the Station, the observer allowed a short period of time before the Survey began, approximately 5 minutes, to allow the birds to resume normal feeding behavior before beginning with data collection. However, even if there are no birds on the feeders after approximately 5 minutes the Survey was conducted.
(7) Feeders were kept at least ¾ full at the beginning of the Survey; if they were less than ¾ full, the feeders were filled and the observer waited for at least 30 minutes to begin a Survey.
(8) Disturbances (such as presence of a predator) that cause birds to significantly alter their feeding behavior were noted on a data sheet.

All bird observations were documented including: the location, date, and type of bird (species) visiting a particular feeder. The total number of birds and species for each feeder was recorded. This study used a network of 22 individual Feeder Observers with 88 bird feeders, 88 shepherd's hooks and squirrel baffles and consumed approximately 17,200 pounds of bird seed, yielding 527 surveys totalling 32,927 bird observations.

### Example 3

### Comparison of Northeast Bird Food Mixture to Wagner's Regional Blend, KAYTEE® Basic Wild Bird Food, and Ordinary Wild Bird Food

Studies were conducted following the protocol described in Example 2 and a bird feed mixture named “Northeast Bird Blend” comprising black oil sunflower seeds, sunflower chips, NYJER® seed (niger oilseed), peanuts, raisins, white millet, safflower, cherries, and pumpkin seeds (described in Table 2) to test its ability to attract desirable birds in a particular region. Surprisingly, the inventor discovered that more birds, (including desirable species such as downy woodpeckers, northern cardinals, white-breasted nuthatches, and purple finches), were attracted to the Northeast Bird Blend as compared to Wagner's Regional Blend, KAYTEE® Basic Wild Bird Food, or ordinary wild bird food.

In Table 3, the number of total birds attracted by the Northeast Bird Blend was compared to Wagner's Regional Blend, KAYTEE® Basic Wild Bird Food, and ordinary wild bird food. The increase in the total number of birds attracted by the Northeast Bird Blend was calculated as a percentage increase over the number of birds attracted by Wagner's Regional Blend, KAYTEE® Basic Wild Bird Food, or ordinary wild bird food.

TABLE 3
Northeast Bird Blend Attracts More Birds

| | | Increase in the | |
|---|---|---|---|
| | | Total Number | |
| Region | Bird Food Mixture | of Birds Attracted | p-value |
| Northeast | Wagner's | 22.74% | 0.167704 |
| Northeast | KAYTEE ® | 218.19% | 1.11E−15 |
| Northeast | ordinary wild bird food | 611.08% | 4.17E−35 |

Further, the inventor surprisingly found that the “Northeast Bird Blend” attracted more bird species as compared to Wagner's Regional Blend, KAYTEE® Basic Wild Bird Food, and ordinary wild bird food.

In Table 4, the number of birds species attracted by the Northeast Bird Blend was compared to Wagner's Regional Blend, KAYTEE® Basic Wild Bird Food, and ordinary wild bird food. The increase in the total number of bird species attracted by the Northeast Bird Blend was calculated as a percentage increase over the number of bird species attracted by Wagner's Regional Blend, KAYTEE® Basic Wild Bird Food, or ordinary wild bird food.

TABLE 4
Northeast Bird Blend Attracts More Bird Species

| | | Increase in the | |
|---|---|---|---|
| | | Number of Bird | |
| Region | Bird Food Mixture | Species Attracted | p-value |
| Northeast | Wagner's | 7.33% | 0.568748 |
| Northeast | KAYTEE ® | 53.93% | 0.000309 |
| Northeast | ordinary wild bird food | 98.98% | 8.73E−08 |

Therefore, the inventor surprisingly found that the Northeast Bird Blend attracted more birds and more species of birds as compared to Wagner's Regional Blend, KAYTEE® Basic Wild Bird Food, or ordinary wild bird food.

### Example 4

### Comparison of Southeast Bird Food Mixture to Wagner's Regional Blend, KAYTEE® Basic Wild Bird Food, and Ordinary Wild Bird Food

Studies were conducted following the protocol described in Example 2 and using a bird Studies were conducted following the protocol described in Example 2 and using a bird feed mixture named “Southeast Bird Blend” comprising black oil sunflower seeds, sunflower chips, NYJER® seed (niger oilseed), peanuts, raisins, white millet, safflower, blueberries, and pumpkin seeds (described in Table 2) to test its ability to attract desirable birds in a particular region. Surprisingly, the inventor discovered that more birds (including desirable species such as American Goldfinch, Brown-headed Nuthatch, Carolina Chickadees, Downy Woodpeckers, House Finch, Indigo Bunting, Northern Cardinals, Northern Mockingbirds, Red-bellied Woodpeckers, and White-breasted Nuthatches) were attracted to the Southeast Bird Blend as compared to Wagner's Regional Blend, KAYTEE® Basic Wild Bird Food, and ordinary wild bird food. Further, the inventor surprisingly found that the “Southeast Bird Blend” attracted more species of birds as compared to Wagner's Regional Blend, KAYTEE® Basic Wild Bird Food, and ordinary wild bird food.

In Table 5, the number of total birds attracted by the Southeast Bird Blend was compared to Wagner's Regional Blend, KAYTEE® Basic Wild Bird Food, and ordinary wild bird food. The increase in the total number of birds attracted by the Southeast Bird Blend was calculated as a percentage increase over the number of birds attracted by Wagner's Regional Blend, KAYTEE® Basic Wild Bird Food, or ordinary wild bird food.

TABLE 5
Southeast Bird Blend Attracts More Birds

| | | Increase in the | |
|---|---|---|---|
| | | Total Number | |
| Region | Bird Food Mixture | of Birds Attracted | p-value |
| Southeast | Wagner's | 18.52% | 0.082206 |
| Southeast | KAYTEE ® | 49.06% | 1.3E−05 |
| Southeast | ordinary wild bird food | 166.16% | 2.78E−23 |

Further, the inventor surprisingly found that the “Southeast Bird Blend” attracted more bird species as compared to Wagner's Regional Blend, KAYTEE® Basic Wild Bird Food, and ordinary wild bird food.

In Table 6, the number of birds species attracted by the Southeast Bird Blend was compared to Wagner's Regional Blend, KAYTEE® Basic Wild Bird Food, and ordinary wild bird food. The increase in the total number of bird species attracted by the Southeast Bird Blend was calculated as a percentage increase over the number of bird species attracted by Wagner's Regional Blend, KAYTEE® Basic Wild Bird Food, or ordinary wild bird food.

TABLE 6
Southeast Bird Blend Attracts More Bird Species

| | | Increase in the | |
|---|---|---|---|
| | | Number of Bird | |
| Region | Bird Food Mixture | Species Attracted | p-value |
| Southeast | Wagner's | 22.91% | 0.034902 |
| Southeast | KAYTEE ® | 28.82% | 0.004998 |
| Southeast | ordinary wild bird food | 85.13% | 4.4E−10 |

Therefore, the inventor surprisingly found that the Southeast Bird Blend attracted more birds and more species of birds as compared to Wagner's Regional Blend, KAYTEE® Basic Wild Bird Food, or ordinary wild bird food.

### Example 5

### Comparison of Midwest Bird Food Mixture to Wagner's Regional Blend, KAYTEE® Basic Wild Bird Food, and Ordinary Wild Bird Food

Studies were conducted following the protocol described in Example 2 and using a bird feed mixture named “Midwest Bird Blend” comprising black oil sunflower seeds, sunflower chips, NYJER® seed (niger oilseed), peanuts, raisins, white millet, safflower, canola seed, and cherries (described in Table 2) to test its ability to attract desirable birds in a particular region. Surprisingly, the inventor discovered that more birds (including desirable species such as American Goldfinch, Carolina Chickadees, Downy Woodpeckers, Purple Finches, Red-breasted & White-breasted Nuthatches, and Tufted Titmice) were attracted to the Midwest Bird Blend as compared to Wagner's Regional Blend, KAYTEE® Basic Wild Bird Food, and Ordinary Wild Bird Food. Further, the inventor surprisingly found that the “Midwest Bird Blend” attracted more species of birds as compared to Wagner's Regional Blend, KAYTEE® Basic Wild Bird Food, and ordinary wild bird food.

In Table 7, the number of total birds attracted by the Midwest Bird Blend was compared to Wagner's Regional Blend, KAYTEE® Basic Wild Bird Food, and ordinary wild bird food. The increase in the total number of birds attracted by the Midwest Bird Blend was calculated as a percentage increase over the number of birds attracted by Wagner's Regional Blend, KAYTEE® Basic Wild Bird Food, or ordinary wild bird food.

TABLE 7
Midwest Bird Blend Attracts More Birds

| | | Increase in the | |
|---|---|---|---|
| | | Total Number | |
| Region | Bird Food Mixture | of Birds Attracted | p-value |
| Midwest | Wagner's | 59.46% | 8.1E−05 |
| Midwest | KAYTEE ® | 109.86% | 1.1E−11 |
| Midwest | ordinary wild bird food | 324.77% | 3.75E−35 |

Further, the inventor surprisingly found that the “Midwest Bird Blend” attracted more bird species as compared to Wagner's Regional Blend, KAYTEE® Basic Wild Bird Food, and ordinary wild bird food.

In Table 8, the number of birds species attracted by the Midwest Bird Blend was compared to Wagner's Regional Blend, KAYTEE® Basic Wild Bird Food, and ordinary wild bird food. The increase in the total number of bird species attracted by the Midwest Bird Blend was calculated as a percentage increase over the number of bird species attracted by Wagner's Regional Blend, KAYTEE® Basic Wild Bird Food, or ordinary wild bird food.

TABLE 8
Midwest Bird Blend Attracts More Bird Species

| | | Increase in the | |
|---|---|---|---|
| | | Number of Bird | |
| Region | Bird Food Mixture | Species Attracted | p-value |
| Midwest | Wagner's | 31.79% | 0.015872 |
| Midwest | KAYTEE ® | 62.77% | 3.2E−06 |
| Midwest | ordinary wild bird food | 103.12% | 1.82E−10 |

Therefore, the inventor surprisingly found that the Midwest Bird Blend attracted more birds and more species of birds as compared to Wagner's Regional Blend, KAYTEE® Basic Wild Bird Food, or ordinary wild bird food.

### Example 6

### Comparison of Western Bird Food Mixture to Wagner's Regional Blend, KAYTEE® Basic Wild Bird Food, and Ordinary Wild Bird Food

Studies were conducted following the protocol described in Example 2 and using a bird feed mixture named “Western Bird Blend” comprising black oil sunflower seeds, sunflower chips, NYJER® seed (niger oilseed), peanuts, raisins, white millet, almonds, and red millet (described in Table 2) to test its ability to attract desirable birds in a particular region. Surprisingly, the inventor discovered that more birds (including desirable species such as American Goldfinches, Dark-eyed Juncos, Mountain Chickadees, Red-breasted Nuthatches, Song Sparrow, and Steller's Jays) were attracted to the Western Bird Blend as compared to KAYTEE® Basic Wild Bird Food or ordinary wild bird food. Further, the inventor surprisingly found that the “Western Bird Blend” attracted more species of birds as compared to Wagner's Regional Blend, KAYTEE® Basic Wild Bird Food, or ordinary wild bird food.

In Table 9, the number of total birds attracted by the Western Bird Blend was compared to Wagner's Regional Blend, KAYTEE® Basic Wild Bird Food, and ordinary wild bird food.

The change in the total number of birds attracted by the Western Bird Blend was calculated as a percentage change versus the number of birds attracted by Wagner's Regional Blend, KAYTEE® Basic Wild Bird Food, or ordinary wild bird food.

TABLE 9
Western Bird Blend Attracts More Birds

| | | Increase in the Number | |
|---|---|---|---|
| Region | Bird Food Mixture | of Birds Attracted | p-value |
| Western | Wagner's | −0.93% | 0.933374 |
| Western | KAYTEE ® | 57.67% | 3.57E−05 |
| Western | ordinary wild bird food | 202.15% | 5.86E−21 |

Further, the inventor surprisingly found that the “Western Bird Blend” attracted more bird species than as compared to Wagner's Regional Blend, KAYTEE® Basic Wild Bird Food, or ordinary wild bird food.

In Table 10, the number of birds species attracted by the Western Bird Blend was compared to Wagner's Regional Blend, KAYTEE® Basic Wild Bird Food, and ordinary wild bird food. The increase in the total number of bird species attracted by the Western Bird Blend was calculated as a percentage increase over the number of bird species attracted by Wagner's Regional Blend, KAYTEE® Basic Wild Bird Food, or ordinary wild bird food.

TABLE 10
Western Bird Blend Attracts More Bird Species

| | | Increase in the | |
|---|---|---|---|
| | | Number of Bird | |
| Region | Bird Food Mixture | Species Attracted | p-value |
| Western | Wagner's | 13.66% | 0.249554 |
| Western | KAYTEE ® | 21.40% | 0.061592 |
| Western | ordinary wild bird food | 60.47% | 2.92E−05 |

Therefore, the inventor surprisingly found that the Western Bird Blend attracted more birds as compared to KAYTEE® Basic Wild Bird Food or ordinary wild bird food and more bird species as compared to Wagner's Regional Blend, KAYTEE® Basic Wild Bird Food, or ordinary wild bird food.

### Example 7

### Comparison of Southwest (1) Bird Food Mixture to Wagner's Regional Blend, KAYTEE® Basic Wild Bird Food, and Ordinary Wild Bird Food

Studies were conducted following the protocol described in Example 2 and using a bird feed mixture named “Southwest Bird Blend (1)” comprising black oil sunflower seeds, sunflower chips, NYJER® seed (niger oilseed), peanuts, raisins, white millet, almonds, safflower, and red millet (described in Table 2) to test its ability to attract desirable birds in a particular region. Surprisingly, the inventor discovered that the “Southwestern (1) Bird Blend” bird feed mixture attracted more birds (including desirable species such as American Goldfinch, Black-throated Sparrow, Cassin's Finch, Canyon Towhee, Lazuli Bunting, Pine Siskin, and Pyrrhuloxia) compared to KAYTEE® Basic Wild Bird Food or Ordinary Wild Bird Food. Further, the inventor surprisingly found that the “Southwest (1) Bird Blend” attracted more species of birds as compared to KAYTEE® Basic Wild Bird Food or ordinary wild bird food.

In Table 11, the number of total birds attracted by the Southwest (1) Bird Blend was compared to Wagner's Regional Blend, KAYTEE® Basic Wild Bird Food, and ordinary wild bird food. The change in the total number of birds attracted by the Southwest (1) Bird Blend was calculated as a percentage change versus the number of birds attracted by Wagner's Regional Blend, KAYTEE® Basic Wild Bird Food, or ordinary wild bird food.

TABLE 11
Southwest (1) Bird Blend Attracts More Birds

| | | Increase in the | |
|---|---|---|---|
| | | Total Number | |
| Region | Bird Food Mixture | of Birds Attracted | p-value |
| Southwest (1) | Wagner's | −17.09% | 0.010985 |
| Southwest (1) | KAYTEE ® | 30.45% | 0.000498 |
| Southwest (1) | ordinary wild bird food | 82.64% | 1.15E−14 |

Further, the inventor surprisingly found that the “Southwest (1) Bird Blend” attracted more bird species as compared to KAYTEE® Basic Wild Bird Food or ordinary wild bird food.

In Table 12, the number of birds species attracted by the Southwest (1) Bird Blend was compared to Wagner's Regional Blend, KAYTEE® Basic Wild Bird Food, and ordinary wild bird food. The change in the total number of bird species attracted by the Southwest (1) Bird Blend was calculated as a percentage change versus the number of bird species attracted by Wagner's Regional Blend, KAYTEE® Basic Wild Bird Food, or ordinary wild bird food.

TABLE 12
Southwest (1) Bird Blend Attracts More Bird Species

| | | Increase in the | |
|---|---|---|---|
| | | Number of Bird | |
| Region | Bird Food Mixture | Species Attracted | p-value |
| Southwest (1) | Wagner's | −0.20% | 0.985479 |
| Southwest (1) | KAYTEE ® | 10.33% | 0.367424 |
| Southwest (1) | ordinary wild bird food | 33.04% | 0.009554 |

Therefore, the inventor surprisingly found that the Southwest (1) Bird Blend attracted more birds and more species of birds as compared to KAYTEE® Basic Wild Bird Food or ordinary wild bird food.

### Example 8

### Comparison of Southwest (2) Bird Food Mixture to Wagner's Regional Blend, KAYTEE® Basic Wild Bird Food, and Ordinary Wild Bird Food

Studies were conducted following the protocol described in Example 2 and using a bird feed mixture named “Southwestern Bird Blend (2)” comprising black oil sunflower seeds, sunflower chips, NYJER® seed (niger oilseed), peanuts, raisins, white millet, almonds, safflower, and red millet (described in Table 2) to test its ability to attract desirable birds in a particular region for 3.5 weeks. Surprisingly, the inventor discovered that the “Southwestern Bird Blend (2)” bird feed mixture attracted more birds (including desirable species such as Black-crested Titmouse, Carolina Chickadees, Chipping Sparrows, Lesser Goldfinches, and Orange-crowned Warblers) compared to Wagner's Regional Blend, KAYTEE® Basic Wild Bird Food, and ordinary wild bird food. Further, the inventor surprisingly found that the “Southwest (2) Bird Blend” attracted more species of birds as compared to Wagner's Regional Blend, KAYTEE® Basic Wild Bird Food, and ordinary wild bird food.

In Table 13, the number of total birds attracted by the Southwest (2) Bird Blend was compared to Wagner's Regional Blend, KAYTEE® Basic Wild Bird Food, and ordinary wild bird food. The increase in the total number of birds attracted by the Southwest (2) Bird Blend was calculated as a percentage increase over the number of birds attracted by Wagner's Regional Blend, KAYTEE® Basic Wild Bird Food, or ordinary wild bird food.

TABLE 13
Southwest (2) Bird Blend Attracts More Birds

| | | Increase in the | |
|---|---|---|---|
| | | Total Number | |
| Region | Bird Food Mixture | of Birds Attracted | p-value |
| Southwest (2) | Wagner's | 31.44% | 0.0214 |
| Southwest (2) | KAYTEE ® | 70.28% | 1.74E−06 |
| Southwest (2) | ordinary wild bird food | 172.83% | 3.71E−17 |

Further, the inventor surprisingly found that the “Southwest (2) Bird Blend” attracted more bird species as compared to Wagner's Regional Blend, KAYTEE® Basic Wild Bird Food, and ordinary wild bird food.

In Table 14, the number of birds species attracted by the Southwest (2) Bird Blend was compared to Wagner's Regional Blend, KAYTEE® Basic Wild Bird Food, and ordinary wild bird food. The increase in the total number of bird species attracted by the Southwest (2) Bird Blend was calculated as a percentage increase over the number of bird species attracted by Wagner's Regional Blend, KAYTEE® Basic Wild Bird Food, or ordinary wild bird food.

TABLE 14
Southwest (2) Bird Blend Attracts More Bird Species

| | | Increase in the | |
|---|---|---|---|
| | | Number of Bird | |
| Region | Bird Food Mixture | Species Attracted | p-value |
| Southwest (2) | Wagner's | 31.88% | 0.06122 |
| Southwest (2) | KAYTEE ® | 47.30% | 0.004445 |
| Southwest (2) | Ordinary wild bird food | 78.52% | 8.57E−05 |

Therefore, the inventor surprisingly found that the Southwest (2) Bird Blend attracted more birds and more species of birds as compared to Wagner's Regional Blend, KAYTEE® Basic Wild Bird Food, or ordinary wild bird food.

Although the invention has been described in some detail by way of illustration and example for purposes of clarity of understanding, it were obvious that certain changes and modifications may be practiced within the scope of the appended claims. Modifications of the above-described modes for carrying out the invention that are obvious to persons of skill in animal physiology, ornithology, zoology, and/or related fields are intended to be within the scope of the following claims.

All publications (e.g., Non-Patent Literature), patents, patent application publications, and patent applications mentioned in this specification are indicative of the level of skill of those skilled in the art to which this invention pertains. All such publications (e.g., Non-Patent Literature), patents, patent application publications, and patent applications are herein incorporated by reference to the same extent as if each individual publication, patent, patent application publication, or patent application was specifically and individually indicated to be incorporated by reference.

1. A bird food mixture comprising black oil sunflower seeds, sunflower chips, niger oilseed, and peanuts, and further comprising:
a. cherries and pumpkin seeds,
b. cherries, pumpkin seeds, and safflower,
c. blueberries and pumpkin seeds,
d. blueberries, pumpkin seeds, and safflower,
e. canola seed and cherries,
f. canola seed, cherries, and safflower,
g. red millet and almonds, or
h. safflower, red millet, and almonds.

2. The mixture of claim 1, wherein said mixture comprises at least about 24.75%-29% black oil sunflower seeds by weight.

3. (canceled)

4. The mixture of claim 1, wherein said mixture comprises at least about 5%-15% sunflower chips by weight.

5. (canceled)

6. The mixture of claim 1, wherein said mixture comprises at least about 10%-18% niger oilseed by weight.

7. (canceled)

8. The mixture of claim 1, wherein said mixture further comprises at least about 3%-20% peanuts by weight.

9. (canceled)

10. The mixture of claim 1, wherein said mixture further comprises at least about 2%-5% raisins by weight.

11. (canceled)

12. The mixture of claim 1, wherein said mixture further comprises at least about 15%-25% white millet by weight.

13. (canceled)

14. The mixture of claim 1, wherein said mixture further comprises mineral oil.

15. (canceled)

16. The mixture of claim 1, wherein said mixture comprises cherries and pumpkin seeds.

17. (canceled)

18. The mixture of claim 1, wherein said mixture comprises cherries, pumpkin seeds, and safflower.

19. (canceled)

20. The mixture of claim 1, wherein said mixture comprises blueberries and pumpkin seeds.

21. (canceled)

22. The mixture of claim 1, wherein said mixture comprises blueberries, pumpkin seeds, and safflower.

23. (canceled)

24. The mixture of claim 1, wherein said mixture comprises canola seed and cherries.

25. (canceled)

26. The mixture of claim 1, wherein said mixture comprises canola seed, cherries, and safflower.

27. (canceled)

28. The mixture of claim 1, wherein said mixture comprises almonds and red millet.

29. (canceled)

30. The mixture of claim 1, wherein said mixture comprises almonds, red millet, and safflower.

31. (canceled)

32. (canceled)

33. A method of manufacturing a bird food mixture comprising combining black oil sunflower seeds, niger oilseed, and peanuts, and further combining
a. cherries and pumpkin seeds,
b. cherries, pumpkin seeds, and safflower,
c. blueberries and pumpkin seeds,
d. blueberries, pumpkin seeds, and safflower,
e. canola seed and cherries,
f. canola seed, cherries, and safflower,
g. red millet and almonds, or
h. safflower, red millet, and almonds.

34. (canceled)

35. (canceled)

36. (canceled)

37. A method for increasing sales of a bird feed mixture comprising combining said bird feed mixture components to manufacture a bird feed mixture, wherein said components are selected based on the dietary needs of desirable birds in a given region, and identifying said mixture as suitable for birds of a specific region.

38. (canceled)

39. (canceled)

40. (canceled)

41. (canceled)

42. A system of regional bird food mixtures comprising at least two mixtures of (a)-(e):
(a) a bird food mixture corresponding to a first region and comprising black oil sunflower seeds, sunflower chips, niger oilseed, peanuts, cherries, and pumpkin seeds;
(b) a bird food mixture corresponding to a second region and comprising black oil sunflower seeds, sunflower chips, niger oilseed, peanuts, blueberries, and pumpkin seeds;
(c) a bird food mixture corresponding to a third region and comprising black oil sunflower seeds, sunflower chips, niger oilseed, peanuts, canola seed, and cherries;
(d) a bird food mixture corresponding to a fourth region and comprising black oil sunflower seeds, sunflower chips, niger oilseed, peanuts, red millet, and almonds; and
(e) a bird food mixture corresponding to a fifth region and comprising black oil sunflower seeds, sunflower chips, niger oilseed, peanuts, safflower, red millet, and almonds.

43. (canceled)

44. (canceled)

45. (canceled)

46. The system of claim 42, wherein at least one of said regions are the northeast, southeast, midwest, southwest, or western regions of the United States.
